(19) United States
(12) Patent Application Publication
(10) Pub. No.: US 2011/0064993 A1
(43) Pub. Date: Mar. 17, 2011

(54) BATTERY ARRAY WITH RELIABLE LOW-RESISTANCE CONNECTIONS

(76) Inventor: Shingo Ochi, Takasago-shi (JP)

(21) Appl. No.: 12/879,259

(22) Filed: Sep. 10, 2010

(30) Foreign Application Priority Data
Sep. 11, 2009 (JP) 2009-210045

(51) Int. Cl. H01M 2/26

(52) U.S. Cl. 429/158

(57) ABSTRACT

The battery array is provided with a plurality of battery cells 1 having positive and negative electrode terminals 2 that are different metals, and the positive and negative electrode terminals 2 of the battery cells 1 are connected by metal plates 3. Each metal plate 3 of the battery array is clad material having a first metal plate 3A that connects to one electrode terminal 2 of a battery cell 1 and a second metal plate 3B that connects to another electrode terminal 2. The clad material first metal plate 3A and second metal plate 3B are joined at a junction between positive and negative electrode terminal 2 connecting regions.

### BACKGROUND OF THE INVENTION

1. Field of the Invention

The present invention relates to a battery array having a plurality of battery cells connected by metal plates, and in particular to a battery array optimally suited for use as a power source for a motor that drives an electric-powered vehicle such as a hybrid car, fuel-cell vehicle, electric automobile (electric vehicle EV), or electric motor-bike.

2. Description of the Related Art

A battery array can connect many battery cells in series to increase output voltage, and in parallel to increase charging current. Accordingly, a high power, high output battery array used as a power source for a motor that drives a vehicle has a plurality of battery cells connected in series to increase output voltage. Since a battery array used in this type of application is charged and discharged with high currents, the plurality of battery cells are connected by low-resistance metal plates. (Refer to Japanese Laid-Open Patent Publication No. H05 343105 (1993).)

In the battery array of JP H05 343105A, both ends of the metal plates are attached to battery cell electrode terminals via nuts. Specifically, electrode terminals are passed through through-holes in the metal plates, and nuts are threaded onto the electrode terminal bolts to attach the metal plates to the electrode terminals. In a battery array with this structure and battery cells having positive and negative electrode terminals made of different type (dissimilar) metals, the contact surfaces of the metal plates and the positive and negative electrode terminals cannot be the same metal type. For example, for lithium ion batteries having dissimilar metal positive and negative electrode terminals that are aluminum and copper connected by copper metal plates, dissimilar metal contact surfaces are formed at the aluminum electrode terminals. A battery array having metal plate and electrode terminal dissimilar metal contact surfaces has the drawback that galvanic corrosion can occur at the dissimilar metal contact surfaces, and stable low contact resistance connections cannot be maintained over a long period. Galvanic corrosion results from current flow between the dissimilar metals, and that current causes metal to electrically dissociate and corrode.

The present invention was developed with the object of correcting the drawback described above. Thus, it is a primary object of the present invention to provide a battery array that can connect battery cell electrode terminals with metal plates in a manner that maintains stable low resistance connections over a long period while connecting different type metals at the positive and negative electrode terminals of the battery cells.

### SUMMARY OF THE INVENTION

The battery array of the present invention is provided with a plurality of battery cells 1, 31 having positive and negative electrode terminals 2, 32 that are different metals, and the positive and negative electrode terminals 2, 32 of each battery cell 1, 31 are connected by metal plates 3, 23, 33, 43, 53. Each metal plate 3, 23, 33, 43, 53 is clad material having a first metal plate 3A, 23A, 33A, 43A, 53A that connects to one electrode terminal 2, 32 of a battery cell 1, 31 and a second metal plate 3B, 23B, 33B, 43B, 53B that connects to a different electrode terminal 2, 32. The clad material first metal plate 3A, 23A, 33A, 43A, 53A and second metal plate 3B, 23B, 33B, 43B, 53B are joined at a junction between positive and negative electrode terminal 2, 32 connecting regions.

The battery array described above has the characteristic that it can connect battery cell electrode terminals in series or parallel with metal plates in a manner that maintains stable low resistance connections over a long period while connecting different type metals at the positive and negative electrode terminals of the battery cells. This is because the first metal plate that connects to one of the electrode terminals of a battery cell and the second metal plate that connects to a different electrode terminal are clad material joined at a junction between the positive and negative electrode terminal connecting regions. Clad material is not simply a laminate of different type metals, but rather is strongly joined together at the junction interface where the different metals are in an alloyed state. Accordingly, in a metal plate made of clad material, there is no ingress of water or air to the junction between the different metals, and galvanic corrosion does not occur at the junction interface. Therefore, metal plates that are dissimilar metal clad material joined at a junction between positive and negative electrode terminals have the characteristic that each electrode terminal can be connected with the same metal type to prevent galvanic corrosion and enable stable electrical connection over a long period.

In the battery array of the present invention, the battery cells 1 can be rectangular battery cells, and metal plates 3, 23, 43 can connect the positive and negative electrode terminals 2 of adjacent battery cells 1 to connect the battery cells 1 in series. Each metal plate 3, 23, 43 has through-holes 4 to insert battery cell 1 positive and negative electrode terminals 2, electrode terminals 2 can be inserted in the through-holes 4, and the electrode terminals 2 and metal plate 3, 23, 43 can be welded for connection. Further, at least one of the through-holes 4 can be an elongated hole 4A to allow the inserted electrode terminals 2 to move in the direction of battery cell 1 stacking. Welding rings 5, can be provided on the surface of the metal plates 3, 23, 43 to close-off open regions of the elongated holes 4A, and the electrode terminals 2 can be welded to the metal plates 3, 23, 43 via the welding rings 5, 25.

The battery array described above has the characteristic that the clad material metal plates can be stably and reliably weld-attached to the electrode terminals while absorbing dimensional error in the battery cells and metal plates via the elongated holes. This is because error in the dimensions of the battery cells and the metal plates can be absorbed by electrode terminal insertion in the elongated holes. In addition, gaps formed by insertion of the electrode terminals in the elongated holes can be closed-off by welding rings, and electrical connection can be made without gaps by welding the welding rings.

In the battery array of the present invention, a welding ring 5, 25 can be either a crimping ring 2X formed by pressure-deformation to widen the upper end of an electrode terminal 2 inserted in an elongated hole 4A, or a metal ring 6 that is a sheet-metal piece separate from the electrode terminal 2 and provided with a center hole 6A for electrode terminal 2 insertion. In this battery array, welding rings formed as crimping rings by widening the ends of the electrode terminals can be weld-attached to the metal plates for reliable connection. Further, with welding rings that are metal rings separate from the electrode terminals, the metal rings can be weld-attached to the electrode terminals and metal plates for reliable electrical connection without putting a load on the electrode terminals.

In the battery array of the present invention, the positive and negative electrode terminals 2, 32 of the battery cells 1, 31 can be aluminum and copper, and the metal plates 3, 23, 33, 43, 53 can be clad material with a junction between first metal plates 3A, 23A, 33A, 43A, 53A and second metal plates 3B, 23B, 33B, 43B, 53B that are aluminum and copper. However, in this patent application, the term aluminum is used in the wider sense to include aluminum alloys, and the term copper is used in the wider sense to include copper alloys.

In the battery array described above, since the electrode terminals are aluminum and copper and the metal plates are also aluminum and copper, the metal plates can be electrically connected to electrode terminals that are the same metal type in a stable manner that does not generate galvanic corrosion.

In the battery array of the present invention, the metal plates 3, 23, 33, 43, 53 can be first metal plates 3A, 23A, 33A, 43A, 53A and second metal plates 3B, 23B, 33B, 43B, 53B joined at junctions with step-shaped interfaces. This battery array has the characteristic that since the junction interfaces are step-shaped, the first metal plates and second metal plates can be stably and reliably joined in a robust manner.

In the battery array of the present invention, the battery cells 1, 31 can be lithium ion batteries. This battery array has the characteristic that since the battery cells are lithium ion batteries, it can increase charging and discharging capacities while being light-weight.

The above and further objects of the present invention as well as the features thereof will become more apparent from the following detailed description to be made in conjunction with the accompanying drawings.

### BRIEF DESCRIPTION OF THE DRAWINGS

FIG. 1 is an oblique view of a battery array for an embodiment of the present invention;

FIG. 2 is an exploded oblique view of the battery array shown in FIG. 1;

FIG. 3 is an exploded oblique view showing the stacking structure of the battery cells and insulating spacers of the battery array shown in FIG. 1;

FIG. 4 is a vertical cross-section of a battery cell;

FIG. 5 is an enlarged oblique view showing connection of the electrode terminals and metal plates of the battery array shown in FIG. 1;

FIG. 6 is an enlarged oblique view showing an assembly step for connecting adjacent electrode terminals with metal plates;

FIG. 7 is an enlarged oblique view showing an assembly step for connecting adjacent electrode terminals with metal plates;

FIG. 8 is an enlarged oblique view of a metal plate;

FIG. 9 is an enlarged oblique view of another example of a metal plate;

FIG. 10 is an exploded oblique view of a battery array for another embodiment of the of the present invention;

FIG. 11 is an enlarged oblique view showing an assembly step for connecting electrode terminals and metal plates of the battery array shown in FIG. 10;

FIG. 12 is an enlarged oblique view showing an assembly step for connecting electrode terminals and metal plates of the battery array shown in FIG. 10;

FIG. 13 is an enlarged oblique view showing an assembly step for connecting electrode terminals and metal plates of the battery array shown in FIG. 10;

FIG. 14 is an exploded oblique view of a battery array for another embodiment of the of the present invention;

FIG. 15 is an enlarged oblique view showing connection of the electrode terminals and metal plates of the battery array shown in FIG. 14;

FIG. 16 is an enlarged oblique view showing another example of a metal plate;

FIG. 17 is an enlarged oblique view showing connection of the electrode terminals and metal plates of a battery array for another embodiment of the of the present invention; and

FIG. 18 is an oblique view of a metal plate shown in FIG. 17.

### DETAILED DESCRIPTION OF THE EMBODIMENT(S)

The following describes embodiments of the present invention based on the figures.

The battery array of the present invention is primarily installed on-board an electric-powered vehicle such as a hybrid car or electric automobile (electric vehicle EV), and is used as a power source to supply power to a driving motor to drive the vehicle.

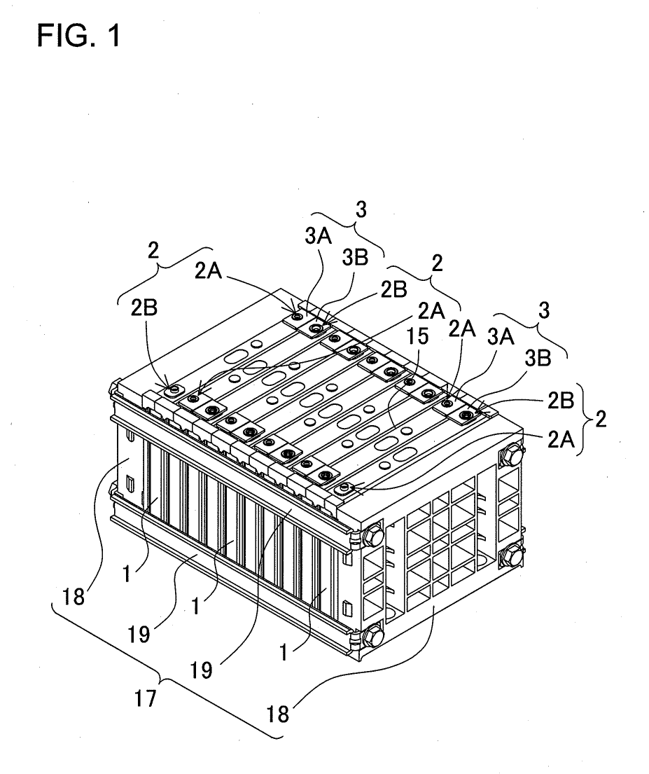

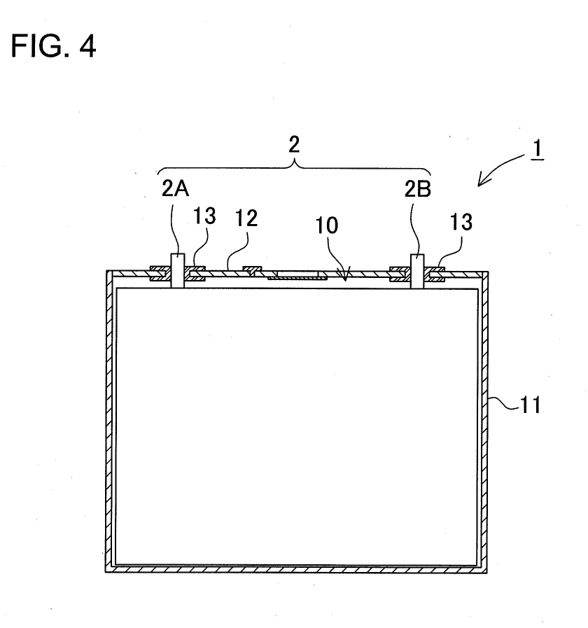

The battery array shown in FIGS. 1-3 has a plurality of battery cells 1 stacked and held together in a manner insulating individual battery cells 1. The battery cells 1 are rectangular battery cells. Further, the rectangular battery cells 1 are lithium ion rechargeable batteries. However, the battery array of the present invention is not limited to battery cells that are rectangular, and also is not limited to lithium ion rechargeable batteries. Any batteries that can be charged, such as nickel hydride batteries, can also be used as the battery cells. As shown in FIG. 4, a rectangular battery cell has an electrode unit 10, which is a stack of positive and negative electrode plates, held in an external case 11 filled with electrolyte and the opening of the external case 11 closed-off in an air-tight manner by a sealing plate 12. The external case 11 of the figure has a rectangular cylindrical-shape with a closed bottom and the opening at the top closed-off in an air-tight manner by the sealing plate 12.

The external case 11 is deep drawn formed metal such as aluminum, and has a conducting surface. The stacked battery cells 1 are formed in thin rectangular-shapes. The sealing plates 12 are fabricated from the same metal as the external case 11 such as aluminum sheet-metal. Each sealing plate 12 has positive and negative electrode terminals 2 mounted on its end regions via insulating material 13. The positive and negative electrode terminals 2 are connected to the internal positive and negative electrode plates. In a lithium ion rechargeable battery, the external case 11 is not connected to an electrode. Since the external case 11 is connected to the internal electrode plates via electrolyte, it attains an intermediate potential between that of the positive and negative electrode plates. However, one of the battery cell electrode terminals can be connected to the external case via a lead-wire as well. In this battery cell, the electrode terminal connected to the external case can be mounted on the sealing plate without insulation.

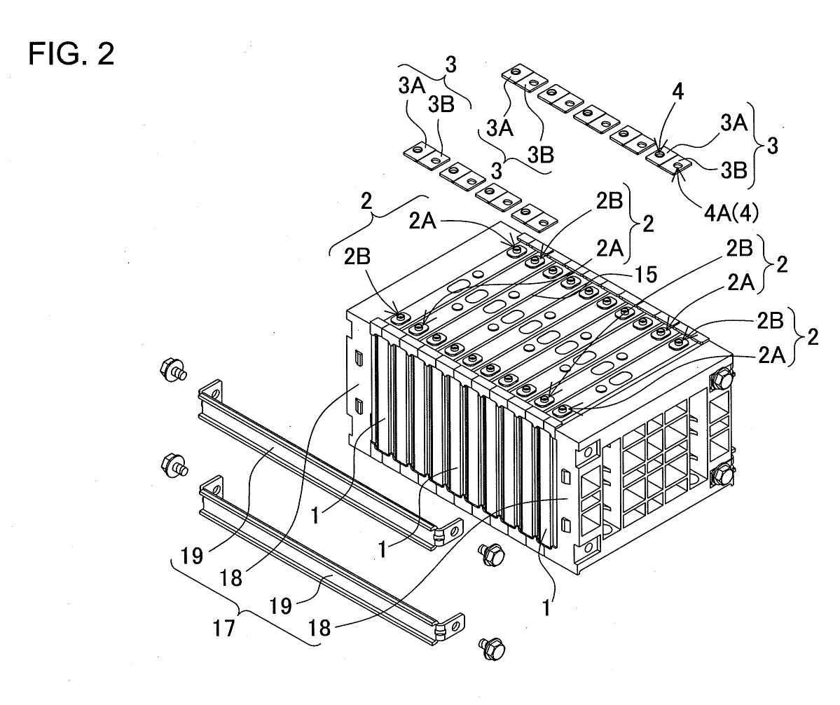

The battery array has a plurality of battery cells 1 stacked to form a rectangular solid block configuration. The battery cells 1 in the figures are stacked in a block configuration in a manner that aligns the electrode terminal 2 surfaces, which are the sealing plate 12 surfaces, in the same plane. The battery array of FIGS. 1 and 2 has electrode terminals 2 disposed on the upper surface of the block. The battery cells 1, which have positive and negative electrode terminals 2 at the end regions of the sealing plates 12, are flipped left-to-right during stacking to reverse the polarity of adjacent electrode terminals 2. As shown in the figures, this battery array has adjacent electrode terminals 2 on both sides of the block connected by metal plates 3 to connect the battery cells 1 in series. The end regions of each metal plate 3 are connected to a positive and negative electrode terminal 2 to connect the battery cells 1 in series. Although the battery array of the figures connects the battery cells 1 in series to increase output voltage, the battery array of the present invention can also connect battery cells in series and parallel to increase output voltage and output current.

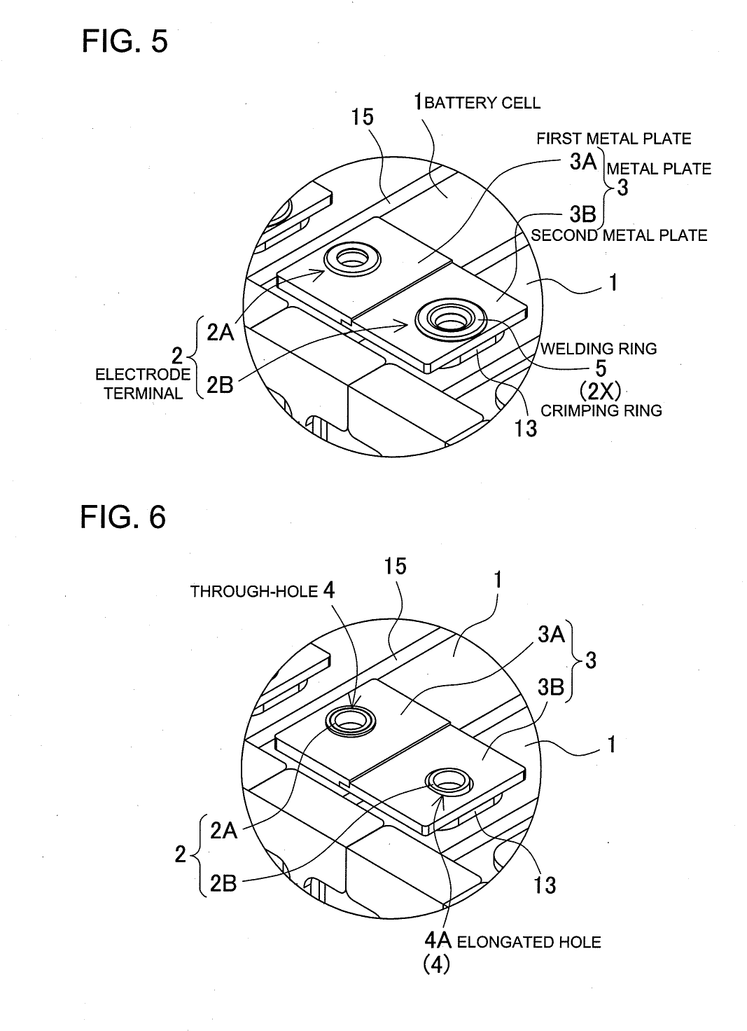

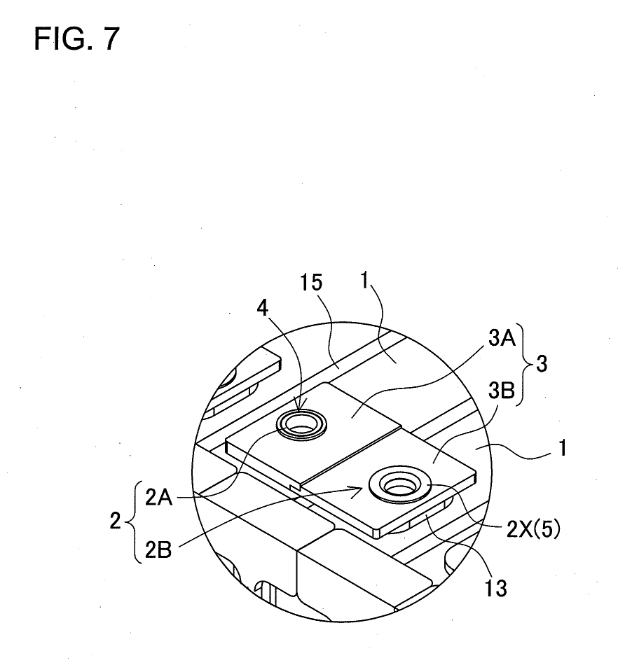

As shown in FIGS. 5-7, the electrode terminals 2 are mounted on the sealing plates 12 via insulating material 13 and have cylindrical ends. Crimping rings 2X can be established by pressure-deformation to widen the ends of cylindrical electrode terminals 2. The electrode terminal 2 of FIG. 7 has a circular cylindrical end and is pressure-deformed to establish a crimping ring 2X. However, the battery array of the present invention does not necessarily require pressure-deformation of the electrode terminals to establish crimping rings. This is because metal plates can be weld-attached to the upper ends of the electrode terminals. These electrode terminals can be circular cylindrical-shaped, polygonal cylindrical-shaped, or they can have ring-shaped projections established around the outsides of the upper ends to weld-attach and connect metal plates to the upper ends.

The positive and negative electrode terminals 2 are not the same type of metal, but rather are different (dissimilar) metals. A lithium ion battery has an aluminum positive electrode 2A and a copper negative electrode 2B. The metal plates 3 have metals connected at either end that are the same as the dissimilar metal electrode terminals 2. A metal plate 3 that connects battery cells 1 with aluminum and copper electrode terminals 2 is clad material with an aluminum first metal plate 3A and a copper second metal plate 3B. A metal plate 3 is clad material with a junction between the first metal plate 3A and the second metal plate 3B at the boundary between electrode terminal 2 connecting regions. This metal plate 3 is connected to battery cell 1 positive and negative electrode terminals 2 with the first metal plate 3A in contact with an aluminum positive electrode 2A and the second metal plate 3B in contact with a copper negative electrode 2B. The first metal plate 3A aluminum does not contact the copper negative electrode 2B, and the second metal plate 3B copper does not contact the aluminum positive electrode 2A.

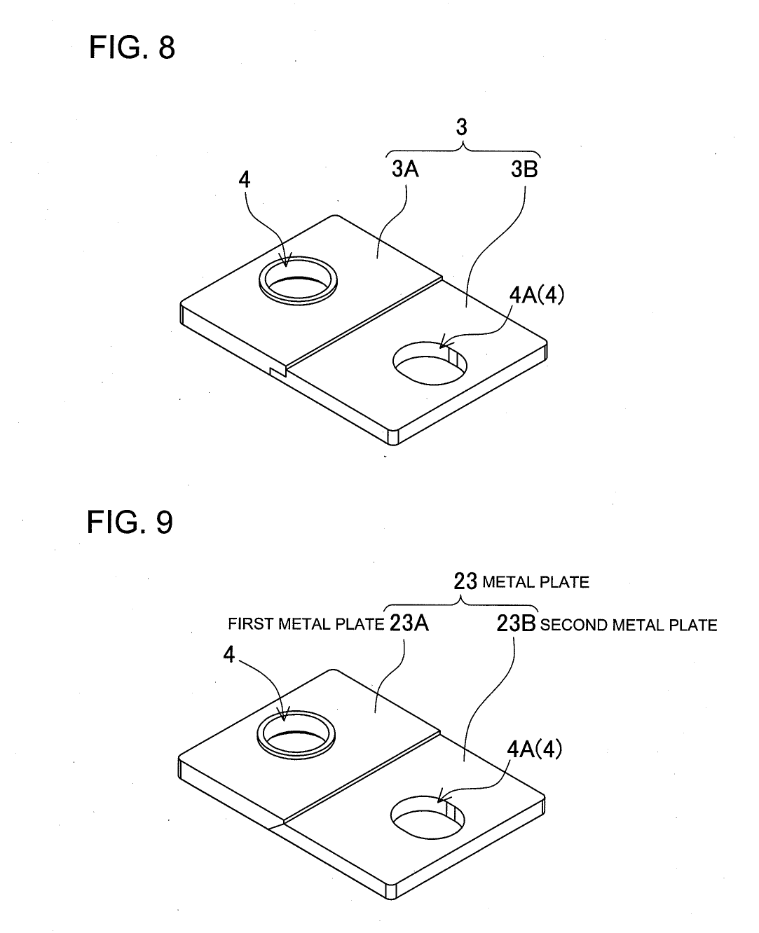

As shown in FIG. 8, a clad material metal plate 3 has a junction at the boundary between the first metal plate 3A and the second metal plate 3B with a step-shape. Or, as shown in FIG. 9, the clad material metal plate 23 has a junction at the boundary between the first metal plate 23A and the second metal plate 23B that is an inclined surface tightly connecting the metal plates. The metal plates 3, 23 of FIGS. 8 and 9 have first metal plate 3A, 23A aluminum that is thicker than second metal plate 3B, 23B copper, and a step is established on the upper surfaces of the clad material.

The metal plates 3 of the figures are provided with through-holes 4 at either end for electrode terminal 2 insertion. Electrode terminals 2 of adjacently disposed battery cells 1 are connected by inserting the electrode terminals 2 through the two through-holes 4 established at the ends of a metal plate 3. Here, an electrode terminal 2 is inserted in a through-hole 4. With the electrode terminal 2 inserted in the through-hole 4, a laser is shined on the boundary between the outside surface of the electrode terminal 2 and the inside surface of the through-hole 4 to laser-weld and attach the electrode terminal 2 and the metal plate 3. To stably and reliably laser-weld a metal plate 3 to an electrode terminal 2, it is important to contact the outside surface of the electrode terminal 2 to the inside surface of the through-hole 4 without gaps. This is because gaps between a through-hole 4 and electrode terminal 2 impede stable connection via laser-welding. Accordingly, the through-holes 4 have an inside diameter that allows tight contact of the inside surface with inserted electrode terminals 2, and specifically, the inside diameter of the through-holes 4 is essentially the same size as the outside diameter of the electrode terminals 2. Therefore, it is necessary to make the inside diameter of the through-holes 4 a size that allows no play between the inserted electrode terminals 2.

To insert two electrode terminals without play in the two through-holes, it is necessary to make the distance between the two electrode terminals precisely equal to the distance between the two through-holes. However, there is error in the dimensions of a battery cell 1, and in a configuration that sandwiches insulating spacers 15 between battery cells 1, there is also error in the dimensions of the insulating spacers 15. Consequently, it is difficult to establish a uniform distance between two adjacent electrode terminals 2. To enable reliable laser-welding of the electrode terminals 2 even when the distance between electrode terminals 2 varies due to dimensional errors, the metal plates 3 of the figures have one of the through-holes 4 made as an elongated hole 4A. An elongated hole 4A has a long narrow shape that extends in a direction allowing the distance between through-holes 4 to vary, which is in the lengthwise direction of the metal plate 3. This allows two electrode terminals 2 with variable distance between the electrode terminals 2 to be inserted in the metal plate 3.

As shown in FIG. 6, when an electrode terminal 2 is inserted in an elongated hole 4A, gaps are established between the electrode terminal 2 and the inside surface of the elongated hole 4A. A welding ring 5 is provided to close-off these gaps. As shown in FIG. 7, the welding ring 5, which is on the upper surface of the metal plate 3, closes-off gaps between the electrode terminal 2 and the elongated hole 4A allowing reliable laser-welding of the metal plate 3 to the electrode terminals 2.

In the battery array of the figures, the through-hole 4 for negative electrode terminal 2B insertion is formed as an elongated hole 4A. Specifically, a circular through-hole 4 is established in the aluminum first metal plate 3A, and an elongated hole 4A is established in the copper second metal plate 3B. In the battery array of FIG. 7, the copper negative electrode 2B is inserted through an elongated hole 4A and the end of the electrode terminal 2 is widened to establish a welding ring 5 that is a crimping ring 2X. The circular cylindrical end of this electrode terminal 2 is pressure-deformed to widen it in a ring-shape to establish the welding ring 5. The welding ring 5, which is a crimping ring 2X, makes contact with the surface of the copper second metal plate 3B. As shown in FIG. 5, the copper negative electrode terminal 2B is reliably connected to the copper second metal plate 3B by laser-welding the perimeter of the crimping ring 2X.

The electrode terminals 2 and metal plates 3 of the battery array described above are connected by the following steps.

(1) As shown in FIG. 6, electrode terminals 2 of adjacent battery cells 1 are inserted in the through-holes 4 at either end of a metal plate 3. A circular electrode terminal 2 is inserted through the circular through-hole 4 and no gaps are formed between the electrode terminal 2 and the through-hole 4. A circular electrode terminal 2 is also inserted through the elongated hole 4A and gaps are formed between the electrode terminal 2 and the elongated hole 4A.

(2) As shown in FIG. 7, the electrode terminal 2 inserted in the elongated hole 4A is pressure-deformed and widened to form a crimping ring 2X on the upper surface of the electrode terminal 2. The outline of the crimping ring 2X is larger than the elongated hole 4A and closes-off the gaps between the elongated hole 4A and the electrode terminal 2.

(3) As shown in FIG. 5, laser energy is focused along the circular perimeter of the circular through-hole 4 to laser-weld the electrode terminal 2 to the metal plate 3. In addition, laser energy is focused along the perimeter edge of the crimping ring 2X, which is the welding ring 5, at the elongated hole 4A to laser-weld the perimeter edge of the welding ring 5 to the metal plate 3.

Although the metal plates 3 described above have one of the through-holes 4 formed as an elongated hole 4A, the battery array of the present invention can also have both through-holes formed as elongated holes. In this battery array, crimping rings are formed by widening the ends of both electrode terminals and perimeter edges of the crimping rings are laser-welded to the metal plates for connection.

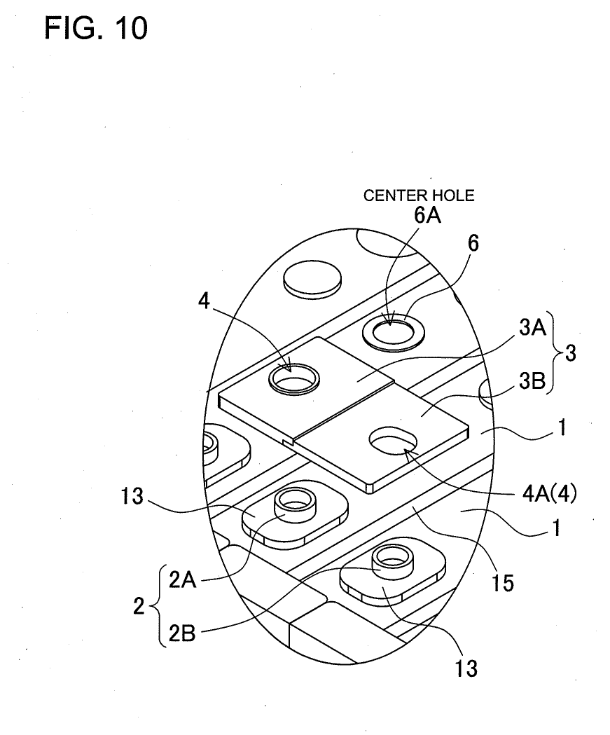

Further, the battery array of FIGS. 10-13 is provided with welding rings 25 that are sheet-metal metal rings 6, which are separate parts from the electrode terminals 2. Since the battery array of the figures has a copper negative electrode 2B inserted in the elongated hole 4A, the metal ring 6 is made from copper the same as the negative electrode 2B. Specifically, the metal ring 6 is made from sheet-metal that is the same material as the electrode terminal 2. In addition, each metal ring 6 is provided with a circular center hole 6A for electrode terminal 2 insertion. The inside diameter of the center hole 6A is approximately equal to the outside diameter of the electrode terminal 2 to allow insertion of the electrode terminal 2 without forming gaps. The outside diameter of a metal ring 6 is a size that enables the elongated hole 4A to be closed-off.

The electrode terminals 2 and metal plates 3 of the battery array described above are connected by the following steps.

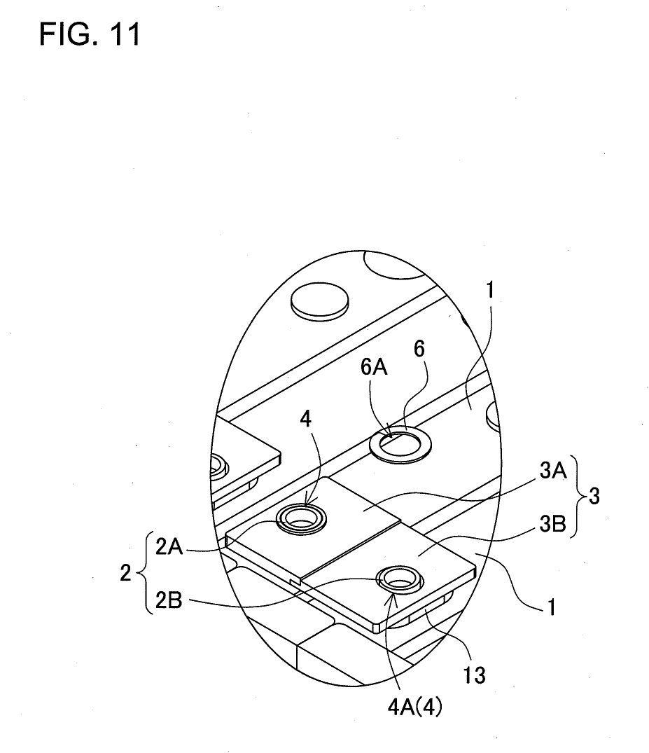

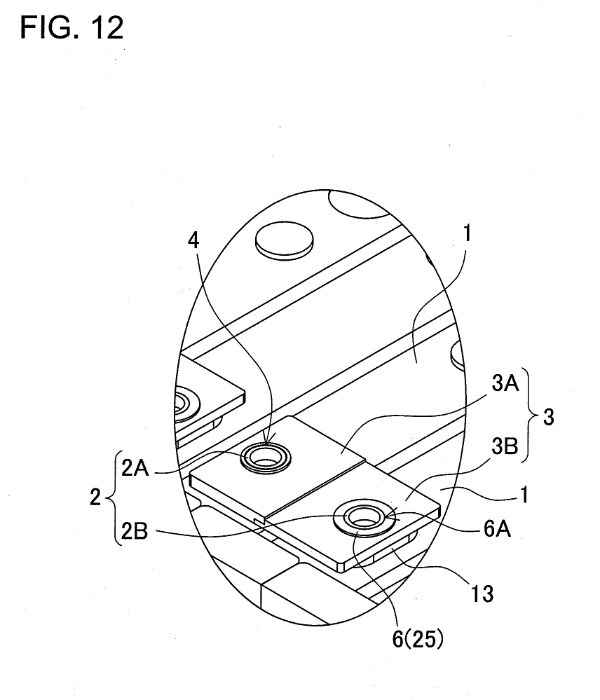

(1) As shown in FIG. 11, electrode terminals 2 of adjacent battery cells 1 are inserted in the through-holes 4 at either end of a metal plate 3. A circular electrode terminal 2 is inserted through the circular through-hole 4 and no gaps are formed between the electrode terminal 2 and the through-hole 4. A circular electrode terminal 2 is also inserted through the elongated hole 4A and gaps are formed between the electrode terminal 2 and the elongated hole 4A.

(2) As shown in FIG. 12, a metal ring 6, which is the welding ring 25, is placed on top of the metal plate 3, and the electrode terminal 2 inserted through the elongated hole 4A is inserted through the charge 6A of the metal ring 6. Since the outline of the metal ring 6 is larger than the elongated hole 4A, gaps between the elongated hole 4A and the electrode terminal 2 are closed-off.

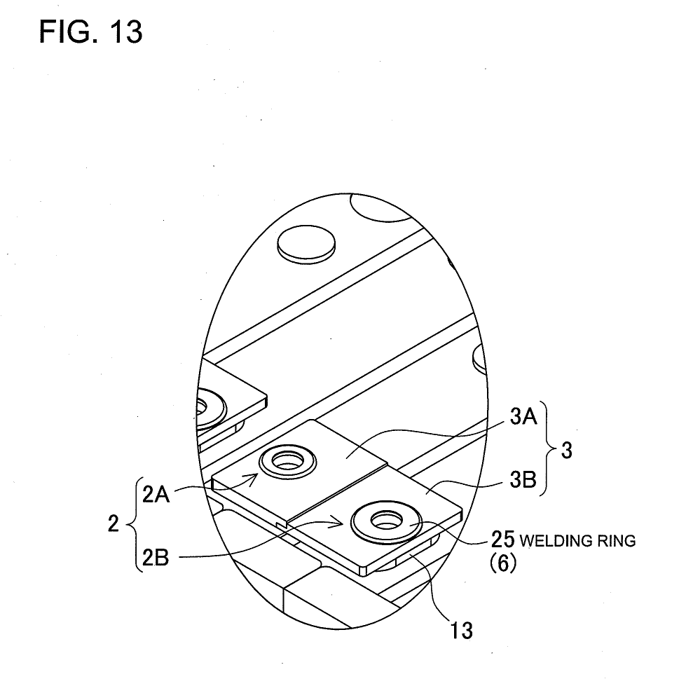

(3) As shown in FIG. 13, laser energy is focused along the circular perimeter of the circular through-hole 4 to laser-weld the electrode terminal 2 to the metal plate 3. In addition, at the elongated hole 4A, laser energy is focused along the inside edge of the center hole 6A and along the outside perimeter edge of the metal ring 6, which is the welding ring 25, to laser-weld the inside edge of the center hole 6A to the electrode terminal 2 and laser-weld the outside perimeter edge to the metal plate 3.

Although the metal plates 3 described above have one of the through-holes 4 formed as an elongated hole 4A, the battery array of the present invention can also have both through-holes formed as elongated holes. In this battery array, both electrode terminals can be inserted through the center holes of metal rings, and the inside and outside perimeter edges of the metal rings can be laser-welded to connect the metal rings to both the electrode terminals and the metal plate.

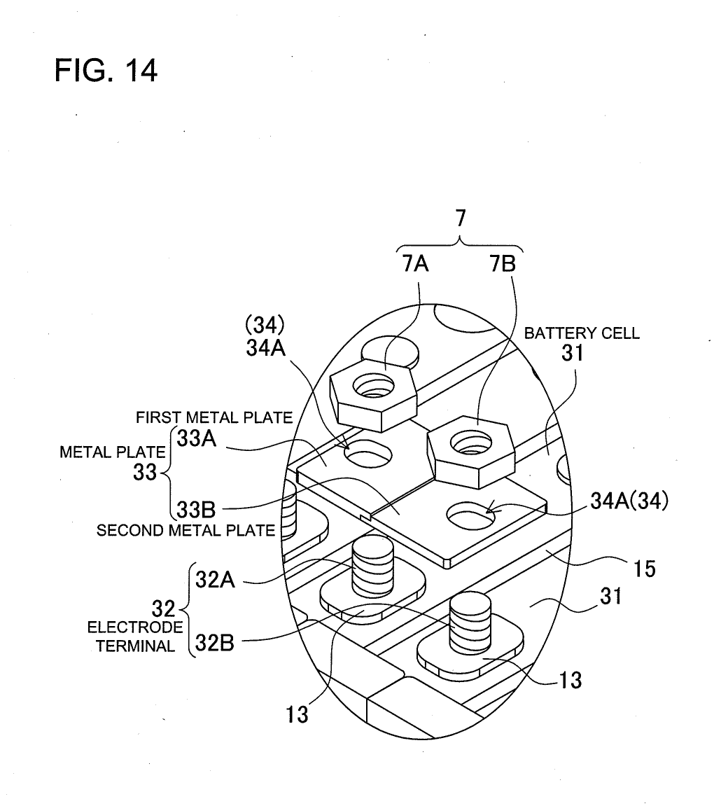

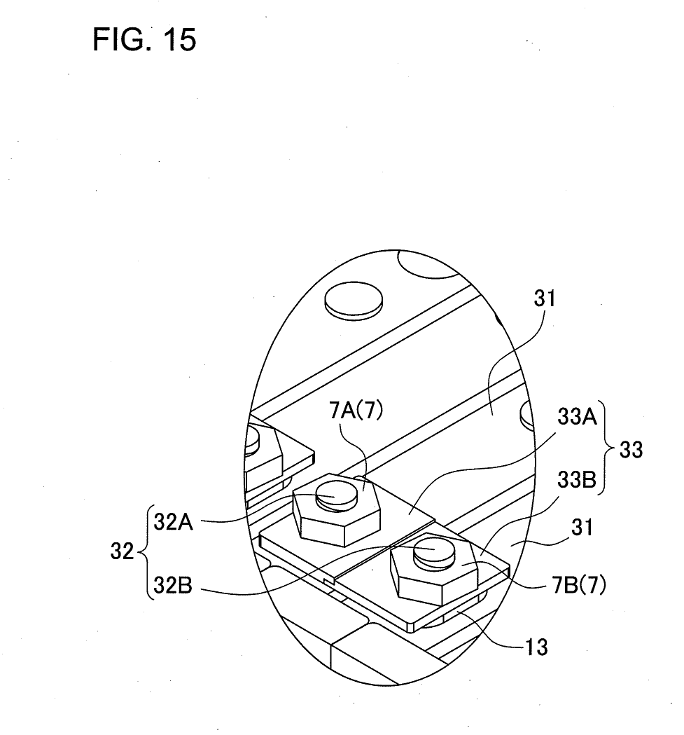

Further, the battery array of FIGS. 14 and 15 has battery cells 31 provided with threaded stud electrode terminals 32 that are inserted through metal plate 33 through-holes 34, and nuts 7 are threaded on those studs to connect the electrode terminals 32 to the metal plate 33. In this battery array, the nuts 7 are made of the same metal as the electrode terminals 32. In a battery array with battery cells 31 having aluminum positive electrodes 32A and copper negative electrodes 32B, the metal plates 33 are clad material with aluminum first metal plates 33A and copper second metal plates 33B. In addition, by making the nuts 7A that screw onto the positive electrodes 32A aluminum and making the nuts 7B that screw onto negative electrodes 32B copper, galvanic corrosion can be prevented. The metal plate 33 shown in the figures has both through-holes 34 made as elongated holes 34A.

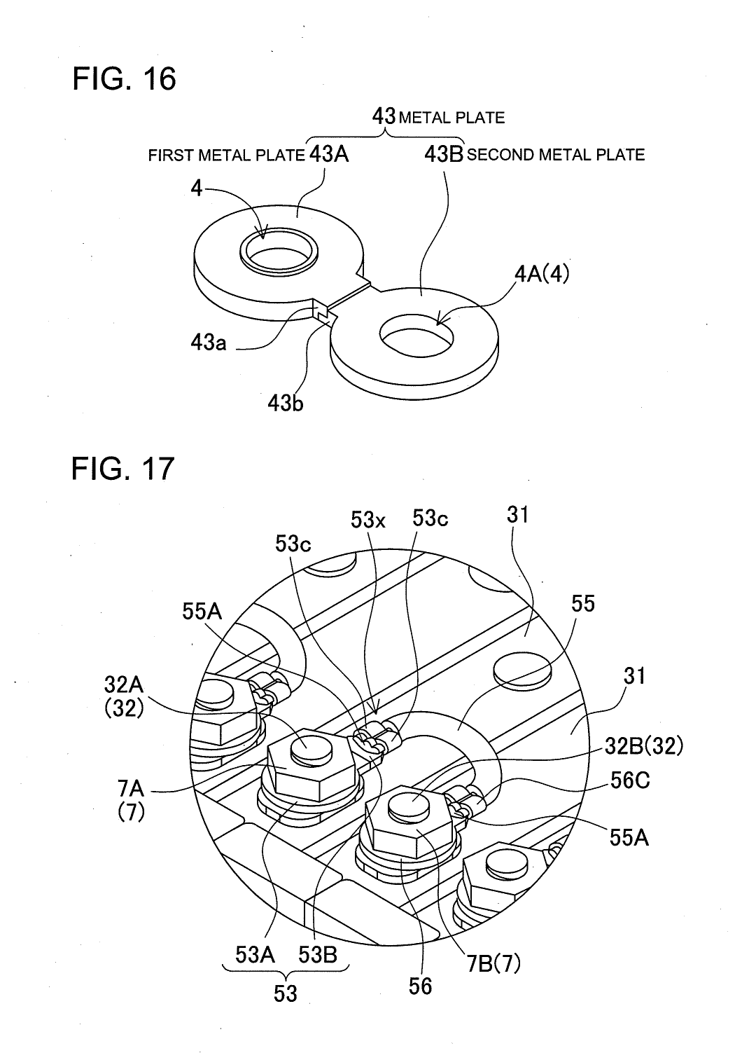

Further, the metal plate 43 of FIG. 16 has both ends, which connect to electrode terminals 2, formed in the shape of terminal connectors. This metal plate 43 has a first metal plate 43A and a second metal plate 43B formed in ring-shapes with through-holes 43A at the center regions. The metal plate 43 is clad material with a junction formed between projections 43a, 43b from the ring-shaped first metal plate 43A and second metal plate 43B. In the same manner as the previously described embodiments, this metal plate 43 is clad material with an aluminum first metal plate 43A and a copper second metal plate 43B. The metal plate 43 of the figure has a junction interface between the first metal plate 43A and the second metal plate 43B that has a step-shape. In addition, this metal plate 43 has one through-hole 4 that is an elongated hole 4A and another through-hole 4 that has a circular-shape. Similar to the previously described metal plates, this metal plate 43 is connected to electrode terminals by laser-welding the electrode terminals inserted through the through-holes, or by screwing nuts onto threaded stud electrode terminals inserted through the through-holes.

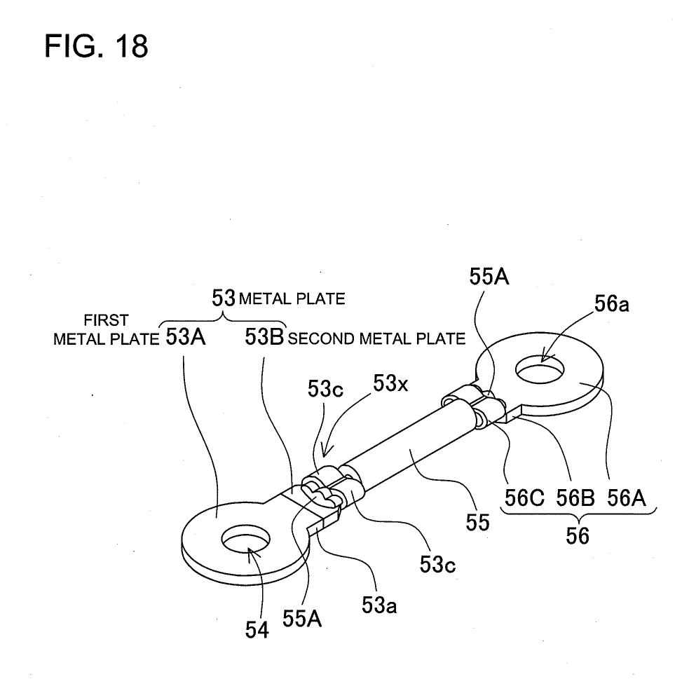

Further, the battery array of FIG. 17 directly connects a first metal plate 53A to one electrode terminal 32, and connects a second metal plate 53B to another electrode terminal 32 through a lead-wire 55 and terminal connector 56. As shown in FIG. 18, this metal plate 53 has a first metal plate 53A formed in a ring-shape with a through-hole 54 at its center region, and is clad material with a junction formed between a projection 53a from the ring-shaped first metal plate 53A and a second metal plate 53B. The second metal plate 53B does not connect directly to an electrode terminal 32, but rather connects to an electrode terminal 32 through a lead-wire 55 and a terminal connector 56. The end of the second metal plate 53B is provided with a crimped region 53x that joins to one end of the lead-wire 55. The second metal plate 53B shown in the figures is provided with projecting pieces 53c that protrude from both sides, and has a crimped region 53x established by curling the pair of projecting pieces 53c in cylindrical-shapes to crimp onto the lead-wire 55 core 55A. With the lead-wire 55 core 55A inserted in the cylindrical-shaped crimped region 53x on the second metal plate 53B, the crimped region 53x is compressed and deformed (crimped) to join the wire core 55A to the crimped region 53x. In addition, a terminal connector 56 is connected to the other end of the lead-wire 55. The terminal connector 56 has a ring section 56A with a through-hole 56a at its center region, and a crimped region 56C is provided on a projection 56B from the ring section 56A to connect the core 55A of the lead-wire 55 by crimping.

The metal plate 53 shown in FIGS. 17 and 18 is also clad material with an aluminum first metal plate 53A and a copper second metal plate 53B. Further, the core 55A of the lead-wire 55 connected to the second metal plate 53B and the terminal connector 56 are the same type metal as the second metal plate 53B. Specifically, the core 55A of the lead-wire 55 is copper wire and the terminal connector 56 is copper plate. The battery array of FIG. 17 has battery cells 31 provided with threaded stud electrode terminals 32, the positive electrode 32A and negative electrode 32B, which are the electrode terminals 32 of adjacent battery cells 31, are inserted through the through-hole 54 in the metal plate 53 and the through-hole 56a in the terminal connector 56, and nuts 7 are screwed onto the electrode terminals 32 to connect the metal plate 53 and the terminal connector 56 to the electrode terminals 32. In this battery array, since the battery cell 1 positive electrodes 32A are aluminum and the negative electrodes 32B are copper, the metal plates 53 are clad material with aluminum first metal plates 53A and copper second metal plates 53B, the cores 55A of the lead-wires 55 are copper wire, and the terminal connectors 56 are copper plates. In addition, the nuts 7A screwed onto positive electrodes 32A are aluminum and the nuts 7B screwed onto negative electrodes 32B are copper to prevent galvanic corrosion.

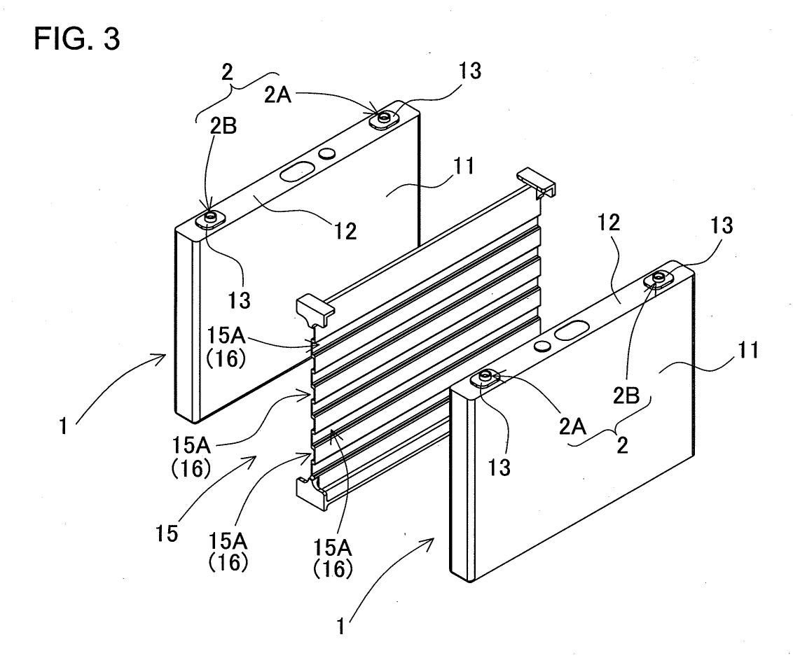

As shown in FIG. 3, battery cells 1 that have metal external cases 11 have insulating spacers 15 sandwiched between adjacent battery cells 1 to electrically insulate the battery cells 1. In addition to insulating adjacent battery cell 1 external cases 11, the insulating spacers 15 establish cooling gaps 16 between the battery cells 1. Accordingly, the insulating spacers 15 are fabricated by molding insulating material such as plastic. An insulating spacer 15 has ventilating grooves 15A formed on both sides that establish the cooling gaps 16 between the insulating spacer 15 and the battery cells 1. An insulating spacer 15 is provided with ventilating grooves 15A extending in the horizontal direction, which is in a direction that joins the two ends of a battery cell 1. Air is passed in a horizontal direction through the cooling gaps 16 established by the insulating spacers 15 to cool the battery cells 1.

The battery cells 1 stacked with intervening insulating spacers 15 are held in fixed positions by fastening components 17 (see FIGS. 1 and 2). The fastening components 17 are made up of a pair of endplates 18 disposed at both end planes of the battery cell 1 stack, and metal bands 19 with ends connected to the endplates 18 to hold the stacked battery cells 1 in a compressed state.

It should be apparent to those with an ordinary skill in the art that while various preferred embodiments of the invention have been shown and described, it is contemplated that the invention is not limited to the particular embodiments disclosed, which are deemed to be merely illustrative of the inventive concepts and should not be interpreted as limiting the scope of the invention, and which are suitable for all modifications and changes falling within the spirit and scope of the invention as defined in the appended claims. The present application is based on Application No. 2009-210045 filed in Japan on Sep. 11, 2009, the content of which is incorporated herein by reference.

What is claimed is:

1. A battery array comprising:
a plurality of battery cells having positive and negative electrode terminals that are dissimilar metals; and
metal plates that connect positive and negative electrode terminals of the battery cells,
wherein each metal plate is clad material with a junction between positive and negative electrode terminal connecting regions of a first metal plate that connects to one battery cell electrode terminal and a second metal plate that connects to another electrode terminal.

2. The battery array as cited in claim 1 wherein the battery cells are rectangular battery cells, a plurality of rectangular battery cells are held in a stacked configuration, and the metal plates connect positive and negative electrode terminals of adjacent battery cells to connect the battery cells in series via the metal plates;
the metal plates have through-holes to insert battery cell positive and negative electrode terminals, electrode terminals are inserted in the through-holes, and the electrode terminals and the metal plates are connected by welding; further, at least one of the through-holes in a metal plate is an elongated hole that allows an inserted electrode terminal to move in the direction of battery cell stacking, a welding ring is provided on the surface of the metal plate to close-off open regions of the elongated hole, and the electrode terminal is weld-attached to the metal plate via the welding ring.

3. The battery array as cited in claim 2 wherein a circular through-hole is provided in the first metal plate, and an elongated hole is provided in the second metal plate.

4. The battery array as cited in claim 3 wherein a circular through-hole is provided in an aluminum first metal plate, and an elongated hole is provided in a copper second metal plate.

5. The battery array as cited in claim 2 wherein the welding ring is a crimping ring formed by widening the end of an electrode terminal inserted through an elongated hole by pressure-deformation.

6. The battery array as cited in claim 5 wherein the outline of the crimping ring is larger than the elongated hole and closes-off gaps between the elongated hole and the electrode terminal.

7. The battery array as cited in claim 5 wherein a copper negative electrode inserted in the elongated hole is pressure-deformed to widen the end of the electrode terminal and establish a welding ring that is a crimping ring.

8. The battery array as cited in claim 2 wherein the welding ring is metal plate separate from an electrode terminal, and is a metal ring provided with a center hole for electrode terminal insertion.

9. The battery array as cited in claim 8 wherein the metal ring is provided with a circular center hole having an inside diameter approximately equal to the outside diameter of an electrode terminal to allow electrode terminal insertion without forming gaps, and the outside diameter of the metal ring is a size that can close-off the elongated hole.

10. The battery array as cited in claim 1 wherein the positive and negative electrode terminals of the battery cells are dissimilar metals that are aluminum and copper, and the metal plates are clad material with a junction between first metal plates and second metal plates that are aluminum and copper.

11. The battery array as cited in claim 1 wherein the metal plates are first metal plates and second metal plates joined at junctions with step-shaped interfaces.

12. The battery array as cited in claim 11 wherein a metal plate has a first metal plate that is thicker than the second metal plate, and a step is established on the upper surface of the clad material.

13. The battery array as cited in claim 1 wherein the metal plates are first metal plates and second metal plates joined at junctions with inclined interface surfaces that tightly connect the metal plates.

14. The battery array as cited in claim 13 wherein a metal plate has a first metal plate that is thicker than the second metal plate, and a step is established on the upper surface of the clad material.

15. The battery array as cited in claim 1 wherein the battery cells are provided with threaded stud electrode terminals that are inserted through metal plate through-holes, and nuts of the same metal type as the electrode terminals are threaded onto the ends of the studs to connect the metal plates to the electrode terminals.

16. The battery array as cited in claim 1 wherein a metal plate has a first metal plate that directly connects to one electrode terminal and a second metal plate that connects to another electrode terminal through a lead-wire and terminal connector; the first metal plate is ring-shaped having a through-hole, the metal plate has a projection from the ring-shaped first metal plate and is clad material with a junction formed between the projection and the second metal plate.

17. The battery array as cited in claim 16 wherein the end of the second metal plate is provided with a crimped region that joins to one end of the lead-wire.

18. The battery array as cited in claim 1 wherein the battery cells are lithium ion batteries.
